(19) United States
(12) Patent Application Publication
(10) Pub. No.: US 2018/0032918 A1
(43) Pub. Date: Feb. 1, 2018

(54) AUTOMATED BOOKING SYSTEMS AND METHODS

(71) Applicant: NCR Corporation, Duluth, GA (US)

(72) Inventors: Mandapati Venkata Pradeep, HYDERABAD TELANGANA (IN); Mohammad Jamal Mohiuddin, KARIMNAGAR TELANGANA (IN); Rajan Vesangi, HYDERABAD (IN)

(21) Appl. No.: 15/219,666

(22) Filed: Jul. 26, 2016

(51) Int. Cl. G06Q 10/02; G06Q 50/14; G06Q 10/10

(52) U.S. Cl. CPC G06Q 10/02; G06Q 10/1093; G06Q 50/14

(57) ABSTRACT

Various embodiments each include at least one of systems, devices, methods, and software for automated booking systems and methods. One method embodiment includes identifying a need for an individual to travel to a destination location of a scheduled event based on at least one calendar entry stored in data of a calendaring system and identifying an origin location and origin and destination airports located in proximity to the origin and destination locations, respectively. The method may then retrieve ground transportation mode options and travel time data from one or more ground transportation routing services for travel from the origin location to the origin airport and from the destination airport to the destination location. The method may then identify flight itinerary options from the origin airport to the destination airport that arrive by a time no later than a start time of the scheduled event less a travel time from the destination airport to the destination location. Next, the method selects and procures a flight itinerary that departs no earlier than an end of an immediately prior scheduled event and no later than a time of the scheduled event less a total time of travel including the selected flight itinerary. Some embodiments may further generate and transmit a message to a messaging account of the individual including at least information about the procured flight itinerary.

### BACKGROUND INFORMATION

Booking travel can be a time consuming process that involves corresponding with travel agents or multiple websites to identify individual options for transport to a destination, hotels, ground transportation, among other travel needs and option. When the travel is for work purposes, the travel bookings must comply with corporate travel policies, per diems, and the like. At the same time, the individual that is traveling may have preferences for airlines, airplane seating, hotels, hotel locations, rental cars or car services, and the many more options for travel and travel service providers. Booking travel can not only be difficult, but also time consuming.

### SUMMARY

Various embodiments each include at least one of systems, devices, methods, and software for automated booking systems and methods. One such embodiment, in the form of a method includes identifying a need for an individual to travel to a destination location of a scheduled event based on at least one calendar entry stored in data of a calendaring system. The method further identifies an origin location and origin and destination airports located in proximity to the origin and destination locations, respectively. The method may then retrieve ground transportation mode options and travel time data from one or more ground transportation routing services for travel from the origin location to the origin airport and from the destination airport to the destination location. The method may then identify flight itinerary options from the origin airport to the destination airport that arrive by a time no later than a start time of the scheduled event less a travel time from the destination airport to the destination location. Next, the method selects and procures a flight itinerary that departs no earlier than an end of an immediately prior scheduled event and no later than a time of the scheduled event less a total time of travel including the selected flight itinerary. Some embodiments may further generate and transmit a message to a messaging account of the individual including at least information about the procured flight itinerary.

Another method embodiment includes identifying a need for an individual to travel from an origin location to a destination location of a scheduled event based on at least one calendar entry stored in data of a computerized calendaring system. This method proceeds by retrieving travel itinerary options through at least one application programming interface call over a network to a provider of travel booking services for travel options from the origin location to the destination location that arrive by a time no later than a start time of the scheduled event less a travel time. The method then automatically selects a retrieved travel itinerary option that departs no earlier than an end of an immediately prior scheduled event, if any, and procures at least a portion of the selected travel itinerary.

A further embodiment is in the form of a system including at least one processor, at least one memory device, and at least one network interface device. The system also includes a travel booking module stored in the at least one memory device and executable by the at least one processor to perform data processing activities. The data processing activities include identifying a need for an individual to travel from an origin location to a destination location of a scheduled event based on at least one calendar entry stored in data of a computerized calendaring system accessed via the at least one network interface device. The data processing activities also include retrieving travel itinerary options through at least one application programming interface call via transmitted via the at least one network interface device over a network to a provider of travel booking services for travel options from the origin location to the destination location that arrive by a time no later than a start time of the scheduled event less a travel time. The data processing activities also include selecting and procure at least a portion of a retrieved travel itinerary option that departs no earlier than an end of an immediately prior scheduled event, if any.

### BRIEF DESCRIPTION OF THE DRAWINGS

FIG. 1 is logical block diagram of a system architecture, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments each include at least one of systems, devices, methods, and software for automated booking systems and methods. More specifically in some embodiments, the booking is with regard to booking travel in an automated or semi-automated manner. Some such embodiments include identifying a need for travel based on a scheduled event, such as a meeting, within a calendaring system. The calendaring system may be a groupware application, email system including calendaring, online calendaring solution, and the like. Scheduled events, when created or modified, often include a location where the meeting will take place. A current location or a previous location can be identified in calendaring data or may be assumed as a “home” location, configured, identified based on global positioning coordinates identified by a mobile device of an individual in various embodiments. When a previous location or a current location is identified that is greater than a certain distance, in some embodiments, such as greater than 300 miles for example, various embodiments herein may automatically or automatically determine travel options, select specific travel options, and book the semi-travel including procuring the travel services.

Travel services are generally services that are utilized while an individual is traveling. Examples of travel services include passenger rail service, airline travel, hotels, car service, rental cars, hotel rooms, restaurant reservations, among other services that may be utilized while traveling.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

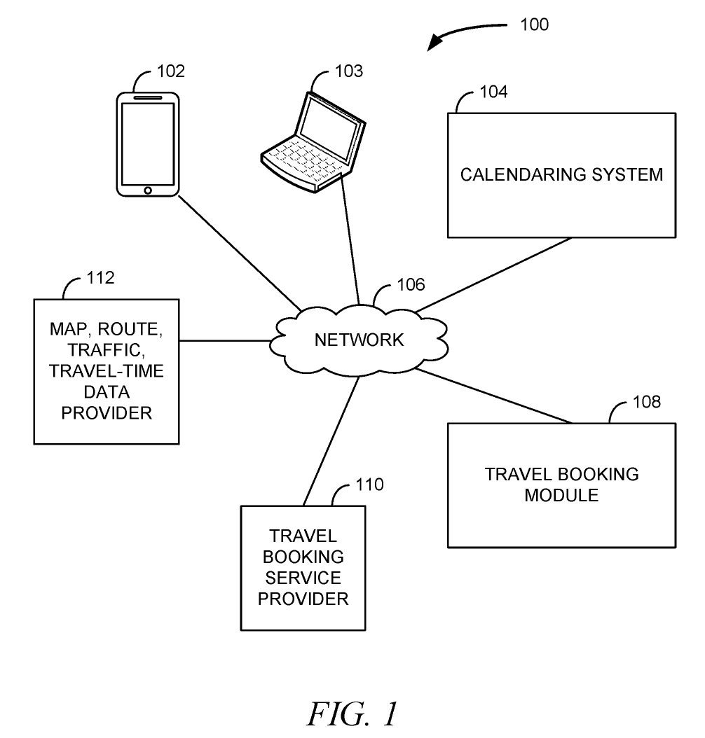

FIG. 1 is logical block diagram of a system 100 architecture, according to an example embodiment. The system 100 is simplified example illustration of some embodiments and includes a number of client devices, such as a smartphone 102 and a personal computer 103. The client devices include calendaring system software apps or applications thereon or are able to access calendaring system software via a web browser app or application.

The system 100 also includes a network 106, such as the Internet, but may also include a local area network, a wireless service network, and other such networks. The client devices connect to the network 106 to exchange data with other devices connected to the network 106. The other devices connected to the network 106 include computers on which a calendaring system 104 and travel booking module 108 execute. The system 100 also includes at least one travel booking service provider 110 and at least one map, route, traffic, and travel-time data provider 112.

The at least one travel booking service provider 110 is a data service provider that provides an application programming interface (API), which may include callable web services, that enables searching for, selecting, and procuring travel services. An example of such a travel booking service provider 110 is Sabre Corporation of Southlake, Tex.

The at least one map, route, traffic, and travel-time data provider 112 is a data service provider that provides data access, via an API, which may include callable web services, that enable retrieval of maps, routes between locations, traffic condition data, and travel-time estimates for travel between locations. Examples of map, route, traffic, and travel-time data providers 112 include the Google Maps APIs available from Google Corporation of Mountain View, Calif. and APIs of MapQuest, Inc. of Denver, Colo.

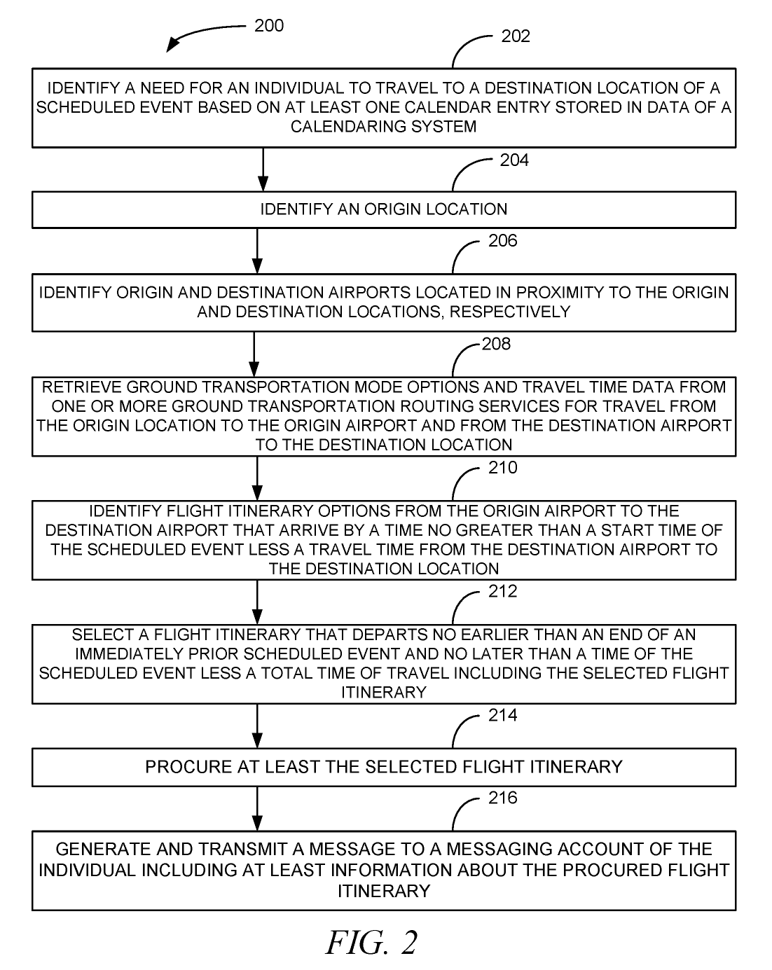

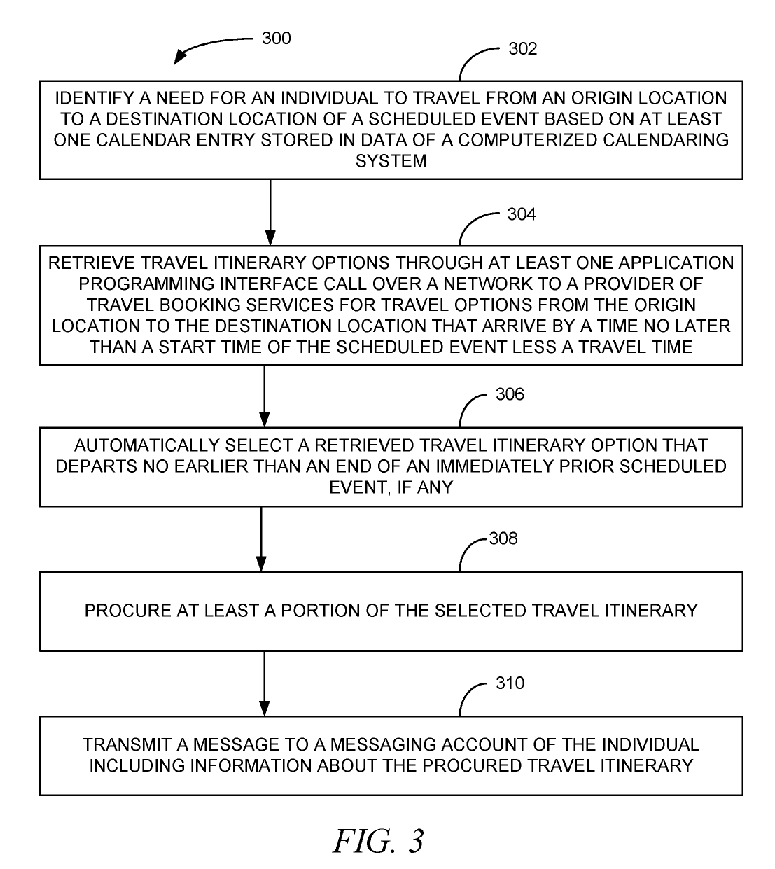

In operation, an individual may schedule a meeting or appointment on their client device, such as the smartphone 102 or personal computer 103, that is stored over the network 106 to the calendaring system 104. When the meeting or appointment (event) is scheduled, a location is associated therewith. The user may request travel booking, a process of the calendaring system may identify a need for travel, or another process may process calendar data on the calendaring system 104 to identify a need for travel booking. Regardless, when travel booking is needed or triggered, the travel booking module 108 begins execution to identify an origin, a destination, time constraints based on data stored in the calendaring system 104 for the individual, and retrieves data from the travel booking service provider 110 and map, route, traffic, and travel-time data provider 112. This data is utilized to assemble a travel itinerary and to procure travel bookings via the travel booking service provider 110. Further details of some such embodiments are further described with regard to methods 200 and 300 of FIG. 2 and FIG. 3, respectively.

FIG. 2 is a block flow diagram of a method 200, according to an example embodiment. The method 200 is an example of a method that may be performed by the travel booking module 108 of FIG. 1.

The method 200 includes identifying 202 a need for an individual to travel to a destination location of a scheduled event based on at least one calendar entry stored in data of a calendaring system. The method 200 then proceeds by identifying 204 an origin location and identifying 206 origin and destination airports located in proximity to the origin and destination locations, respectively. The method 200 may then retrieve 208 ground transportation mode options and travel time data from one or more ground transportation routing services, such as the map, route, traffic, and travel-time service provider 112 of FIG. 1, for travel from the origin location to the origin airport and from the destination airport to the destination location.

The method 200 may then proceed by identifying 210 flight itinerary options from the origin airport to the destination airport that arrive by a time no later than a start time of the scheduled event less a travel time from the destination airport to the destination location. A flight itinerary may then be selected 212 that departs no earlier than an end of an immediately prior scheduled event and no later than a time of the scheduled event less a total time of travel including the selected flight itinerary. The method 200 may then proceed to procuring 214 at least the selected flight itinerary followed by generating and transmitting 216 a message to a messaging account of the individual including at least information about the procured flight itinerary.

In some embodiments of the method 200, the identification 202 of the need for travel occurs when a scheduled event is first stored or modified. Further, identifying 204 the origin location may include identifying a location of the immediately prior scheduled event or a known home or office location when the immediately prior scheduled event has either no location data stored in the calendaring system or the immediately prior scheduled event is disparate in time from the scheduled event.

In some embodiments, at least one of the identifying 210 of flight itinerary options and selecting 212 of the flight itinerary is performed in view of one or more travel policies that impose conditions on selecting travel options, such as corporate travel policies that limit or specify airlines, rental car companies, hotels, class of service, and the like, unless there are no other options. The travel policies may also include or be travel preferences of the individual.

In some embodiments, generating and transmitting 216 the message including at least the information about the procured flight itinerary includes generating and storing at least one calendar entry for the procured flight itinerary for a date and time with regard to the flight from the origin airport. In other embodiments, the message may be a text message, an email, a notification within a mobile device app, and other such messages.

In some embodiments of the method 200, procuring 214 at least the selected flight itinerary further includes booking and procuring transportation from the destination airport to the destination location. Charges associated with the procuring 214 may charged to an account established with the travel booking service provider 110, a credit card of an organization or the individual for whom travel is being procured, be billed after the fact, and the like.

Some embodiments of the method 200 described thus far may be completely automated. Some further embodiments may include transmitting a viewable data representation (e.g., web page, email, etc.) of the identified 210 flight itinerary options for viewing by the individual and the method 200 may pause at that point awaiting input from the individual or a designee thereof. In such embodiments, selecting 212 the flight itinerary includes receiving selection input with regard to a flight itinerary option in response to the transmitting of the viewing data representation of the identified flight itinerary options.

FIG. 3 is a block flow diagram of a method 300, according to an example embodiment. The method 300 is another example of a method that may be performed by the travel booking module 108 of FIG. 1.

The method 300 includes identifying 302 a need for an individual to travel from an origin location to a destination location of a scheduled event based on at least one calendar entry stored in data of a computerized calendaring system. The method 300 may then retrieve 304 travel itinerary options through at least one application programming interface call over a network to a provider of travel booking services for travel options from the origin location to the destination location that arrive by a time no later than a start time of the scheduled event less a travel time. The method 300 then automatically selects 306 a retrieved travel itinerary option that departs no earlier than an end of an immediately prior scheduled event, if any, and procures 308 the selected travel itinerary. Some embodiments of the method may further include transmitting 310 a message to a messaging account of the individual including information about the procured travel itinerary.

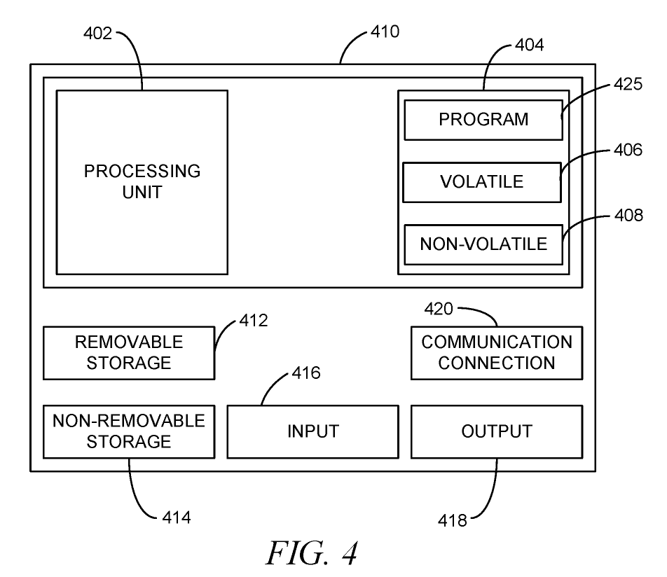

FIG. 4 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be a smartphone, a tablet, smartwatch, or other computing device including the same or similar elements as illustrated and described with regard to FIG. 4. Devices such as smartphones, tablets, and smartwatches are generally collectively referred to as mobile devices. Further, although the various data storage elements are illustrated as part of the computer 410, the storage may also or alternatively include cloud-based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, camera, one or more device-specific buttons, one or more sensors integrated within or coupled via wired or wireless data connections to the computer 410, and other input devices. The computer 410 may operate in a networked environment using a communication connection 420 to connect to one or more remote computers, such as database servers, web servers, and other computing device. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 420 may also or alternatively include a transceiver device, such as a BLUETOOTH® device that enables the computer 410 to wirelessly receive data from and transmit data to other BLUETOOTH® devices.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
identifying a need for an individual to travel to a destination location of a scheduled event based on at least one calendar entry stored in data of a calendaring system;
identifying an origin location;
identifying origin and destination airports located in proximity to the origin and destination locations, respectively;
retrieving ground transportation mode options and travel time data from one or more ground transportation routing services for travel from the origin location to the origin airport and from the destination airport to the destination location;
identifying flight itinerary options from the origin airport to the destination airport that arrive by a time no greater than a start time of the scheduled event less a travel time from the destination airport to the destination location;
selecting a flight itinerary that departs no earlier than an end of an immediately prior scheduled event and no later than a time of the scheduled event less a total time of travel including the selected flight itinerary;
procuring at least the selected flight itinerary; and
generating and transmitting a message to a messaging account of the individual including at least information about the procured flight itinerary.

2. The method of claim 1, wherein the identification of the need for travel occurs when a scheduled event is first stored or modified.

3. The method of claim 1, wherein identifying the origin location includes:
identifying a location of the immediately prior scheduled event or a known home or office location when the immediately prior scheduled event has either no location data stored in the calendaring system or the immediately prior scheduled event is disparate in time from the scheduled event.

4. The method of claim 1, wherein at least one of the identifying of flight itinerary options and selecting of the flight itinerary are performed in view of one or more travel policies that impose conditions on selecting travel options.

5. The method of claim 4, wherein at least one travel policy limits selection of travel options to certain travel service providers unless there is no other option.

6. The method of claim 4, wherein at least one travel policy is a set of stored travel preferences of the individual.

7. The method of claim 1, wherein generating and transmitting the message including at least the information about the procured flight itinerary includes generating and storing at least one calendar entry for the procured flight itinerary for a date and time with regard to the flight from the origin airport.

8. The method of claim 1, wherein retrieving ground transportation mode options and travel time data includes retrieving at least a portion of the data via an application programming interface call over a network from a provider of map, route, traffic, and travel-time data.

9. The method of claim 1, wherein identifying flight itinerary options and procuring at least the selected flight itinerary includes making application programming interface calls over a network to a provider of travel booking services.

10. The method of claim 9, wherein procuring at least the selected flight itinerary further includes booking and procuring transportation from the destination airport to the destination location.

11. The method of claim 1, further comprising:
transmitting a viewable data representation of the identified flight itinerary options for viewing by the individual; and
wherein selecting the flight itinerary includes receiving selection input with regard to a flight itinerary option in response to the transmitting of the viewing data representation of the identified flight itinerary options.

12. A method comprising:
identifying a need for an individual to travel from an origin location to a destination location of a scheduled event based on at least one calendar entry stored in data of a computerized calendaring system;
retrieving travel itinerary options through at least one application programming interface call over a network to a provider of travel booking services for travel options from the origin location to the destination location that arrive by a time no later than a start time of the scheduled event less a travel time;
automatically selecting a retrieved travel itinerary option that departs no earlier than an end of an immediately prior scheduled event, if any;
procuring at least a portion of the selected travel itinerary.

13. The method of claim 12, wherein the need for travel is identified by a process that executes against calendar entries stored in the data of the computerized calendaring system.

14. The method of claim 12, further comprising:
setting the origin location by identifying a location of the immediately prior scheduled event or a known home or office location when the immediately prior scheduled event has either no location data stored in the calendaring system or the immediately prior scheduled event is disparate in time from the scheduled event.

15. The method of claim 12, wherein at least one of the retrieving of travel itinerary options and the automatically selecting of the travel itinerary options are performed in view of one or more travel policies that impose conditions on selecting travel options.

16. The method of claim 15, wherein at least one travel policy is a set of stored travel preferences of the individual.

17. A system comprising:
at least one processor;
at least one memory device;
at least one network interface device; and
a travel booking module stored in the at least one memory device and executable by the at least one processor to perform data processing activities comprising:
identifying a need for an individual to travel from an origin location to a destination location of a scheduled event based on at least one calendar entry stored in data of a computerized calendaring system accessed via the at least one network interface device;
retrieving travel itinerary options through at least one application programming interface call via transmitted via the at least one network interface device over a network to a provider of travel booking services for travel options from the origin location to the destination location that arrive by a time no later than a start time of the scheduled event less a travel time;
selecting a retrieved travel itinerary option that departs no earlier than an end of an immediately prior scheduled event, if any; and
procuring at least a portion of the selected travel itinerary.

18. The system of claim 17, wherein the data processing activities further comprise:
transmitting, via the at least one network interface device, a renderable dataset including the retrieved travel itinerary options to the individual or other designated recipient; and
wherein selecting a retrieved travel itinerary option includes receiving input with regard to one of the retrieved travel itinerary options included in the transmitted renderable dataset.

19. The system of claim 17, wherein the retrieved travel itinerary options include car service to and from travel terminals involved in the respective itinerary.

20. The system of claim 17, wherein identifying the need for the individual to travel includes receiving input originating from a calendaring system client by the individual with regard to the at least one calendaring entry.
